(19) United States
(12) Patent Application Publication
(10) Pub. No.: US 2026/0222762 A1
(43) Pub. Date: Jul. 30, 2026

(54) ELECTRONIC DEVICE FOR LOCATION ESTIMATION, AND METHOD FOR OPERATING SAME

(71) Applicant: Samsung Electronics Co., Ltd., Suwon-si (KR)

(72) Inventors: Junsu CHOI, Suwon-si (KR); Gibeom KIM, Suwon-si (KR); Jusik YUN, Suwon-si (KR)

(21) Appl. No.: 19/629,811

(22) Filed: Mar. 26, 2026

Related U.S. Application Data
(63) Continuation of application No. PCT/KR2024/016621, filed on Oct. 29, 2024.

(30) Foreign Application Priority Data
Oct. 31, 2023 (KR) 10-2023-0147667
Nov. 30, 2023 (KR) 10-2023-0171150

(51) Int. Cl. H04W 4/021

(52) U.S. Cl. CPC H04W 4/021

(57) ABSTRACT

An electronic device may include: a communication circuit; at least one processor comprising processing circuitry; and a memory, wherein the memory stores instructions which, when executed by the at least one processor, cause the electronic device to: identify information related to a first signal strength pattern of multiple external electronic devices arranged within a designated space; generate a second signal strength pattern of the electronic device by a scan related to operating frequencies of the multiple external electronic devices; identify an external electronic device having the signal strength pattern corresponding to the second signal strength pattern; and identify the location of the electronic device based on the location at which the external electronic device is arranged within the designated space.

### CROSS-REFERENCE TO RELATED APPLICATIONS

This application is a continuation of International Application No. PCT/KR2024/016621 designating the United States, filed on October 29, 2024, in the Korean Ministry of Intellectual Property Receiving Office, and claiming priority to Korean Patent Application Nos. 10-2023-0147667, filed on October 31, 2023, and 10-2023-0171150, filed on November 30, 2023, in the Korean Ministry of Intellectual Property, the disclosures of each of which are incorporated by reference herein in their entireties.

### BACKGROUND

### FIELD

1The disclosure relates to an electronic device for location estimation and an operation method thereof.

### DESCRIPTION OF RELATED ART

2 With the development of wireless communication technologies, various objects include a communication function to form a network, thereby enabling a user to conveniently control the objects through an electronic device. A function of forming a network by including a communication function in an object may be referred to as Internet of things (IoT). The Internet of Things (IoT) may be applied to various fields, such as smart homes, smart buildings, smart cities, smart cars (or connected cars), smart grids, health care, smart home appliances, or advanced medical services, through the convergence and complex of communication technologies and various industries.

3 Among various services to which the IoT technology is applied, in the case of a smart home environment, various services based on the Internet of Things may be provided by utilizing various IoT devices. An electronic device such as a smartphone may execute an application for managing each of the IoT devices.

4 The above-described information may be provided as related art for the purpose of facilitating an understanding of the disclosure. No assertion or determination is made as to whether any of the foregoing is applicable as prior art with respect to the disclosure.

5 When using IoT technologies (e.g., a smart home function), an electronic device may identify or control states of various objects located in a designated space (e.g., a home) through communication connections with the various objects. The smart home function may include a home automation function of automatically controlling at least one object corresponding to the location of the electronic device within a designated space. For example, the home automation function may include a series of operations of, when the electronic device is located in a first area (e.g., a master bedroom) within a designated space, turning on lighting disposed in the first area, or starting a heating and cooling system corresponding to the first area.

6 An electronic device may need a method for relatively reliably identifying (or estimating) the location of the electronic device within a designated space for a home automation function.

### SUMMARY

7 Embodiments of the disclosure provide a device and a method for identifying (or estimating), by an electronic device, the location of the electronic device within a designated space.

8 According to an example embodiment, an electronic device may include: a communication circuit, at least one processor, comprising processing circuitry, operatively connected to the communication circuit, and memory storing instructions. According to an example embodiment, the instructions, when executed individually and/or collectively by at least one processor, cause the electronic device to: identify information related to first signal strength patterns of multiple external electronic devices disposed within a designated space; generate a second signal strength pattern of the electronic device through scanning related to operating frequencies of the multiple external electronic devices; based on a signal strength pattern corresponding to the second signal strength pattern existing among the first signal strength patterns, identify an external electronic device having the signal strength pattern corresponding to the second signal strength pattern; and identify a location of the electronic device, based on a location at which the external electronic device is disposed within the designated space.

9 According to an example embodiment, a method of operating an electronic device may include: identifying information related to first signal strength patterns of multiple external electronic devices disposed within a designated space; generating a second signal strength pattern of the electronic device through scanning related to operating frequencies of the multiple external electronic devices; based on a signal strength pattern corresponding to the second signal strength pattern existing among the first signal strength patterns, identifying an external electronic device having the signal strength pattern corresponding to the second signal strength pattern; and identifying a location of the electronic device, based on a location at which the external electronic device is disposed within the designated space.

According to an example embodiment, a non-transitory computer-readable storage medium (or computer program product) storing one or more programs may be provided. According to an example embodiment, the one or more programs may include an instruction that, when executed by at least one processor, comprising processing circuitry, individually and/or collectively, of an electronic device, causes the electronic device to perform operations comprising: identifying information related to first signal strength patterns of multiple external electronic devices disposed within a designated space, generating a second signal strength pattern of the electronic device through scanning related to operating frequencies of the multiple external electronic devices, based on a signal strength pattern corresponding to the second signal strength pattern existing among the first signal strength patterns, identifying an external electronic device having the signal strength pattern corresponding to the second signal strength pattern, and identifying a location of the electronic device, based on a location at which the external electronic device is disposed within the designated space.

According to an example embodiment of the disclosure, an electronic device may identify (or estimate) a location of the electronic device within a designated space, based on signal strength patterns of signals received from external electronic devices disposed in a designated space, so as to identify (or estimate) the location of the electronic device without using a separate device for location estimation within the designated space.

According to an example embodiment, the electronic device may identify (or generate) signal strength patterns related to external electronic devices for identifying (or estimating) a location of the electronic device through scanning related to operating frequencies of the external electronic devices disposed in the designated space, so as to reduce a time required for identifying (or estimating) the location of the electronic device within the designated space.

According to an example embodiment, the electronic device may identify (or generate) signal strength patterns related to external electronic devices for identifying (or estimating) a location of the electronic device, based on results of multiple scans related to operating frequencies of the external electronic devices disposed in the designated space, so as to increase the reliability of identifying (or estimating) the location of the electronic device within the designated space.

According to an example embodiment, the electronic device may identify (or estimate) a location of the electronic device within the designated space, based on a signal strength pattern related to the external electronic devices disposed in the designated space and information related to a valid device configured for each area within the designated space, so as to increase the reliability of identifying (or estimating) the location of the electronic device within the designated space.

In addition to this, various effects directly or indirectly identified through this disclosure may be provided.

The effects obtainable from the disclosure are not limited to the above-mentioned effects, and other effects not mentioned may be clearly understood through the following description by those skilled in the art to which the disclosure belongs.

### BRIEF DESCRIPTION OF THE DRAWINGS

In relation to the description of drawings, the same or similar reference numerals may be used for the same or similar components. Further, the above and other aspects, features and advantages of certain embodiments of the present disclosure will be more apparent from the following detailed description, taken in conjunction with the accompanying drawings, in which:

FIG. 1 is a block diagram of an example electronic device in a network environment according to various example embodiments.

FIG. 2 is a diagram illustrating an example of identifying a location of an electronic device within a designated space according to various example embodiments.

FIG. 3 is a block diagram illustrating an example configuration of an electronic device for identifying a location of an electronic device within a designated space according to various example embodiments.

FIG. 4 is a signal flow diagram illustrating example operations for identifying a location of an electronic device within a designated space by the electronic device according to various example embodiments.

FIG. 5 is a flowchart illustrating example operations for sharing information related to a signal strength pattern by an external electronic device according to various example embodiments.

FIG. 6 is a flowchart illustrating example operations for identifying a location of an electronic device based on a signal strength pattern of an external electronic device by the electronic device according to various example embodiments.

FIG. 7 is a flowchart illustrating example operations for selecting an external electronic device based on a similarity of signal strength patterns by an electronic device according to various example embodiments.

FIG. 8 is a graph illustrating an example for identifying a similarity of signal strength patterns by an electronic device according to various example embodiments.

FIG. 9 is a flowchart illustrating example operations for identifying a location of an electronic device based on information related to a valid device by an electronic device according to various example embodiments.

FIG. 10 is a flowchart illustrating example operations for identifying a location of an electronic device based on information related to a valid device by an electronic device according to various example embodiments.

### DETAILED DESCRIPTION

Hereinafter, embodiments will be described in detail reference to the attached drawings.

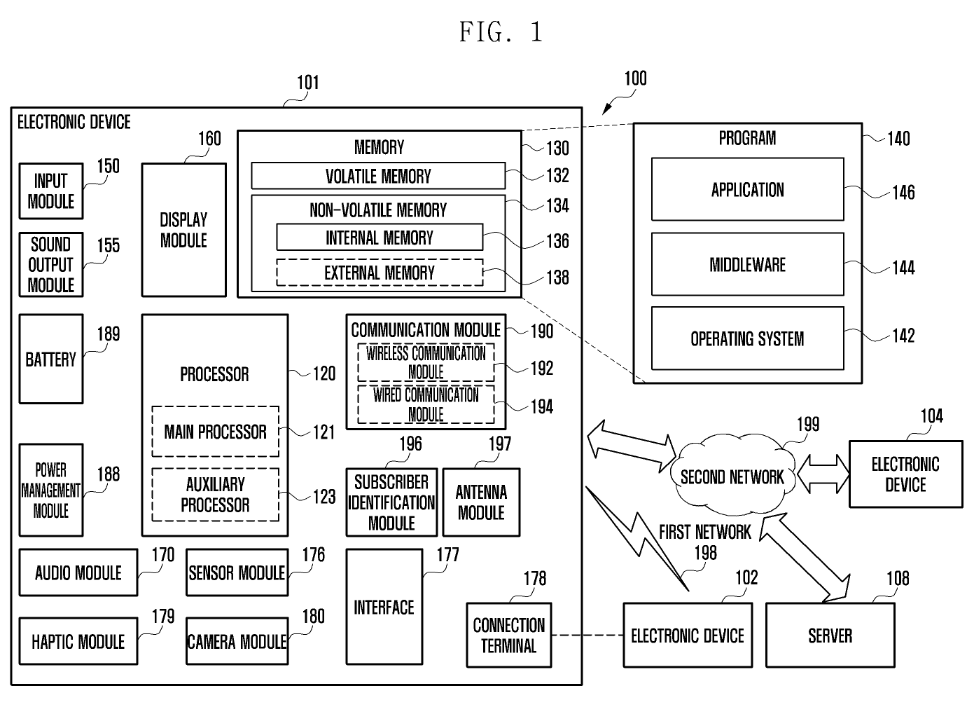

FIG. 1 is a block diagram illustrating an example electronic device 101 in a network environment 100 according to various example embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC. According to an embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form high frequency (e.g., a mmWave) antenna module. According to an embodiment, the high frequency (e.g., the mmWave) antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include patch array antennas and/or dipole array antennas. For example, the plural antennas may include patch array antennas and/or dipole array antennas.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), the element may be coupled with the other element directly (e.g., wiredly), wirelessly, or via a third element.

As used in connection with various embodiments of the disclosure, the term "module" may include a unit implemented in hardware, software, or firmware, or any combination thereof, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the "non-transitory" storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

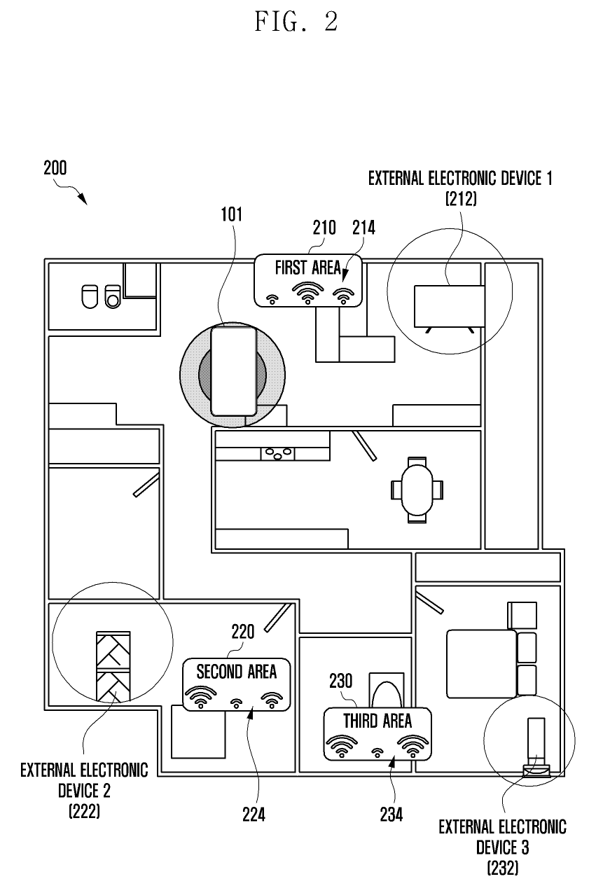

FIG. 2 is a diagram illustrating an example for identifying a location of an electronic device within a designated space according to various example embodiments.

According to an embodiment referring to FIG. 2, a designated space 200 may be divided into multiple areas 210, 220 and/or 230. For example, the designated space 200 (e.g., a home) may be divided into a first area 210 (e.g., a living room), a second area 220 (e.g., room 1), and a third area 230 (e.g., room 2). For example, the designated space 200 may be a space to which an Internet of things (IoT) technology is applied, and may include at least one of a home, a car, a store, an office, a building, or a city, based on the field to which the IoT technology is applied.

According to an embodiment, external electronic devices 212, 222, and/or 232 may be disposed in a specific area 210, 220, or 230 within the designated space 200. For example, external electronic device 1212 may be disposed in the first area 210 of the designated space 200. External electronic device 2222 may be disposed in the second area 220 of the designated space 200. External electronic device 3232 may be disposed in the third area 230 of the designated space 200. For example, the external electronic devices 212, 222, and/or 232 may include a device related to an IoT function capable of transmitting and receiving a signal while being disposed within the designated space 200. For example, the external electronic devices 212, 222, and/or 232 may include at least one of a home appliance, an access point (AP), a light, or a switch.

According to an embodiment, when the external electronic devices 212, 222, and/or 232 are registered with the IoT function, the external electronic devices may register, with the IoT function, at least one of information related to a location at which each external electronic device 212, 222, or 232 is disposed or an operating frequency. For example, the IoT function may be a node for controlling the IoT function of the electronic device 101, and may be configured by a software or a separate hardware device (e.g., a server).

According to an embodiment, the external electronic devices 212, 222, and/or 232 may generate signal strength patterns 214, 224 and/or 234 while being disposed within the designated space 200. For example, when an event related to a signal strength pattern occurs, the external electronic devices 212, 222, and/or 232 may identify the quality of a signal received from the external electronic devices 212, 222, and/or 232 disposed within the designated space 200. The external electronic device 212, 222, or 232 may generate a signal strength pattern 214, 224, or 234 of the external electronic device 212, 222, or 232, based on the quality of the signal received from the external electronic devices 212, 222, and/or 232. For example, the signal strength pattern 214, 224, or 234 may include a set of qualities of signals (e.g., signal strength) received from the external electronic devices 212, 222, and/or 232 determined to be disposed within the designated space 200 in which the external electronic device 212, 222, or 232 is disposed. For example, the signal strength pattern 214 of the external electronic device 1212 may include a set of qualities of signals received by the external electronic device 1212 from the external electronic device 1212 and the other external electronic devices 222 and/or 232 disposed in the designated space 200. For example, the signal strength pattern 224 of the external electronic device 2222 may include a set of qualities of signals received by the external electronic device 2222 from the external electronic device 2222 and the other external electronic devices 212 and/or 232 disposed in the designated space 200. For example, the signal strength pattern 234 of the external electronic device 3232 may include a set of qualities of signals received by the external electronic device 3232 from the external electronic device 3232 and the other external electronic devices 212 and/or 222 disposed in the designated space 200. For example, the signal quality may include an average value of signal qualities identified (or measured) for a designated time, or a most recently identified (or measured) signal quality. For example, a signal quality may include at least one of a received signal strength indicator (RSSI), reference signal received quality (RSRQ), reference signal received power (RSRP), signal to noise ratio (SNR), signal to interference and noise ratio (SINR), quality of service (QoS), or bit error rate (BER). For example, the event related to the signal strength pattern may occur based on arrival of a designated first period, execution of an application program or function related to generation of a signal strength pattern, or reception of a control signal related to generation of a signal strength pattern. For example, the designated first period may indicate a period configured to generate a signal strength pattern by the external electronic device 212, 222, or 232.

According to an embodiment, each external electronic device 212, 222, or 232 may transmit information related to the signal strength pattern 214, 224, or 234 of the external electronic device 212, 222, or 232 to the electronic device 101 located in the designated space 200. For example, when an event related to sharing of the signal strength pattern occurs, the external electronic devices 212, 222, and/or 232 may transmit, to the electronic device 101, information related to the signal strength pattern 214, 224, or 234 generated by each external electronic device 212, 222, or 232. For example, the event related to sharing of the signal strength pattern may occur based on arrival of a designated second period, execution of an application program or function related to sharing of the signal strength pattern, or reception of a control signal related to entry of the electronic device 101 into the designated space 200. For example, the designated second period is a period indicating a time point for sharing of the signal strength pattern 214, 224, or 234 by the external electronic device 212, 222, or 232, and may be configured to be the same as or longer than the designated first period. For example, the information related to the signal strength pattern 214, 224, or 234 may be transmitted based on a short-range communication scheme including at least one of a wireless LAN (e.g., Wi-Fi), Bluetooth (or Bluetooth low energy (BLE)), or ultra-wideband (UWB).

According to an embodiment, in case of entering the designated space 200, the electronic device 101 may identify a signal strength pattern of the external electronic devices 212, 222, and/or 232 disposed in the designated space 200.

According to an embodiment, when an event related to location estimation occurs within the designated space 200, the electronic device 101 may generate a signal strength pattern of the electronic device 101 related to the external electronic devices 212, 222, and/or 232 disposed within the designated space 200. For example, the electronic device 101 may identify information related to operating frequencies of the external electronic devices 212, 222, and/or 232 disposed within the designated space 200. The electronic device 101 may identify the quality of signals received from the external electronic devices 212, 222, and/or 232 through scanning related to the operating frequencies of the external electronic devices 212, 222, and/or 232. The electronic device 101 may generate a signal strength pattern of the electronic device 101, based on the quality of the signals received from the external electronic devices 212, 222, and/or 232. For example, the event related to location estimation may occur based on execution of an application program or function related to location estimation, reception of an input (e.g., a touch input, a gesture input, or a voice input) related to location estimation, or reception of a control signal related to location estimation. For example, the operating frequencies of the external electronic devices 212, 222, and/or 232 may be acquired from the respective external electronic devices 212, 222, and/or 232 or a node (e.g., a server) which controls an IoT function.

For example, the electronic device 101 may generate a signal strength pattern of the electronic device 101, based on results of multiple scans related to the operating frequencies of the external electronic devices 212, 222 and/or 232. For example, the signal strength pattern of the electronic device 101 may be generated based on an average value of the quality of signals received from the external electronic devices 212, 222, and/or 232 identified based on the results of the multiple scans. For example, the scanning may include a series of operations of transmitting a request signal related to location estimation and receiving a response signal corresponding to the request signal to identify a signal quality.

According to an embodiment, the electronic device 101 may identify (or estimate) a location of the electronic device 101 within the designated space 200, based on the signal strength pattern of the electronic device 101 and the signal strength pattern of the external electronic devices 212, 222, and/or 232. For example, the electronic device 101 may identify a similarity between the signal strength pattern of the electronic device 101 and the signal strength pattern of the external electronic device 212, 222, or 232. For example, the similarity may indicate a degree of similarity between the signal strength pattern of the electronic device 101 and the signal strength pattern of the external electronic device 212, 222, or 232. For example, when the electronic device 101 fails to receive a signal of at least one external electronic device (e.g., the external electronic device 3232) among the external electronic devices 212, 222, and/or 232 disposed within the designated space 200, the similarity may indicate a degree of similarity between the signal strength pattern of the electronic device 101 and a signal strength pattern formed by the remaining external electronic devices 212 and 222, excluding an external electronic device (e.g., the external electronic device 3232) from which the electronic device 101 fails to receive a signal, among signal strength patterns of the respective external electronic devices 212, 222, or 232.

For example, the electronic device 101 may identify whether the external electronic device 212, 222, or 232 satisfying a designated similarity condition exists among the external electronic devices 212, 222, and/or 232. For example, the external electronic device satisfying the designated similarity condition may include an external electronic device for which a similarity between the signal strength pattern of the external electronic device 212, 222, or 232 and the signal strength pattern of the electronic device 101 is equal to or greater than a designated reference similarity.

For example, the electronic device 101 may determine, as an area in which the electronic device 101 is located, the area 210, 220, or 230 in which the external electronic device 212, 222, or 232 having the highest similarity to the signal strength pattern of the electronic device 101 among the external electronic devices 212, 222, or 232 satisfying the designated similarity condition is disposed.

For example, when the external electronic device 212, 222, or 232 satisfying the designated similarity condition does not exist, the electronic device 101 may determine that location estimation of the electronic device 101 within the designated space 200 has failed. For example, a state in which the designated similarity condition is not satisfied may include a state in which there is no external electronic device 212, 222, and/or 232 for which a similarity between the signal strength pattern of the external electronic device 212, 222, or 232 and the signal strength pattern of the electronic device 101 is greater than or equal to the designated reference similarity.

For example, the electronic device 101 may identify a valid device of the area 210, 220, or 230 in which the external electronic device 212, 222, or 232 having the highest similarity to the signal strength pattern of the electronic device 101 is disposed. For example, when it is determined that the electronic device 101 has received a signal of the valid device, the electronic device 101 may determine, as an area in which the electronic device 101 is located, the area 210, 220, or 230 in which the external electronic device 212, 222, or 232 having the highest similarity to the signal strength pattern of the electronic device 101 is disposed. For example, when it is determined that the electronic device 101 has not received the signal of the valid device, the electronic device 101 may determine that location estimation of the electronic device 101 within the designated space 200 has failed. For example, a valid device of a specific area 210, 220, or 230 may include an external electronic device identified to be disposed in the specific area 210, 220, or 230 within the designated space 200. For example, the external electronic device 1212 may be configured as a valid device of the first area 210 within the designated space 200. For example, the external electronic device 2222 may be configured as a valid device of the second area 220 within the designated space 200. For example, the external electronic device 3232 may be configured as a valid device of the third area 230 within the designated space 200. For example, a state in which it is determined that a signal of a valid device has been received may include a state in which the electronic device 101 has received a signal having a strength greater than or equal to a designated second reference strength from the valid device.

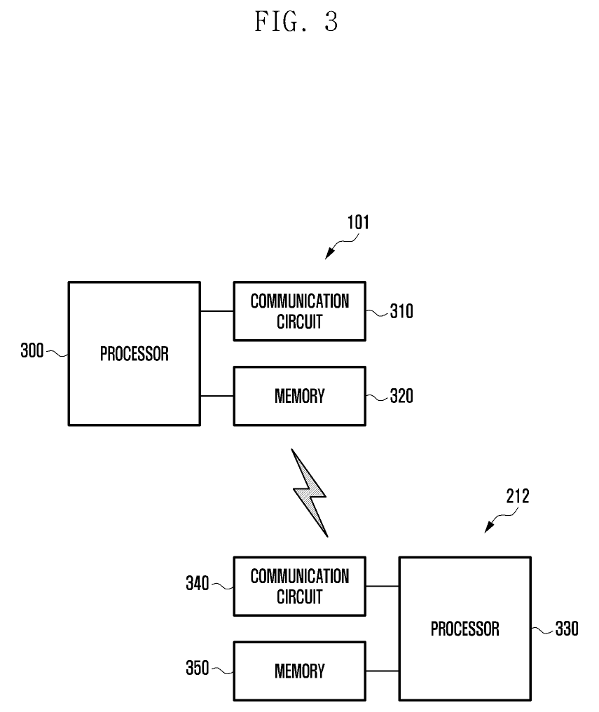

FIG. 3 is a block diagram illustrating an example configuration of an electronic device for identifying a location of an electronic device within a designated space according to various example embodiments. For example, the electronic device 101 of FIG. 3 may be at least partially similar to the electronic device 101 of FIG. 1 or FIG. 2 or may include various embodiments of the electronic device. For example, the external electronic device 212 of FIG. 3 may be at least partially similar to the electronic device 101 of FIG. 1 or the external electronic device 1212 of FIG. 2, or may include various embodiments of the electronic device. For example, the external electronic device 2222 and/or the external electronic device 3232 of FIG. 2 may be configured to be similar to or partially different from the external electronic device 212 of FIG. 3.

According to an embodiment referring to FIG. 3, the electronic device 101 may include at least one of a processor (e.g., including processing circuitry) 300, a communication circuit (or communication circuitry) 310, and/or a memory 320. For example, the processor 300 may be substantially the same as the processor 120 of FIG. 1 or may be included in the processor 120 and thus a repeated description may not be provided here. The communication circuit 310 may be substantially the same as the wireless communication module 192 of FIG. 1 or may be included in the wireless communication module 192. The memory 320 may be substantially the same as the memory 130 of FIG. 1 or may be included in the memory 130. For example, the processor 300 may include at least one of an application processor or a communication processor. For example, the processor 300 may be operatively, functionally, and/or electrically connected to at least one of the communication circuit 310 or the memory 320. For example, the processor 300 may include at least one processor including processing circuitry.

According to an embodiment, when the electronic device 101 enters a designated space 200, the processor 300 may identify a signal strength pattern of the external electronic devices 212, 222, and/or 232 disposed within the designated space 200. For example, when a signal having a strength equal to or greater than a designated first reference strength is received from the external electronic devices 212, 222, and/or 232 disposed in the designated space 200, the processor 300 may determine that the electronic device 101 has entered the designated space 200. For example, the processor 300 may identify entry into the designated space 200 of the electronic device 101, based on a location estimation scheme (e.g., a satellite navigation system).

According to an embodiment, when an event related to location estimation occurs within the designated space 200, the processor 300 may generate a signal strength pattern of the electronic device 101 related to the external electronic devices 212, 222, and/or 232 disposed within the designated space 200. For example, when the event related to location estimation occurs within the designated space 200, the processor 300 may control the communication circuit 310 to perform scanning related to operating frequencies of the external electronic devices 212, 222, and/or 232 disposed within the designated space 200. For example, the scanning may include a series of operations of transmitting a request signal related to location estimation and receiving a response signal corresponding to the request signal to identify a signal quality. For example, the request signal related to location estimation may be a signal for generating a response of the external electronic device 212, 222, or 232, and may include at least one of a probe request signal or a domain name system (DNS) query. For example, the event related to location estimation may occur based on execution of an application program or function related to location estimation, reception of an input (e.g., a touch input, a gesture input, or a voice input) related to location estimation, or reception of a control signal related to location estimation. For example, the operating frequencies of the external electronic devices 212, 222, and/or 232 may be acquired from the respective external electronic devices 212, 222, and/or 232 or a node (e.g., a server) which controls an IoT function.

For example, the processor 300 may generate a signal strength pattern of the electronic device 101, based on the quality of signals received from the external electronic devices 212, 222, and/or 232 identified through the scanning related to the operating frequencies of the external electronic devices 212, 222, and/or 232.

For example, the electronic device 101 may generate a signal strength pattern of the electronic device 101, based on results of multiple scans related to the operating frequencies of the external electronic devices 212, 222 and/or 232. For example, the number of scans for generating the signal strength pattern of the electronic device 101 may include a designated number. For example, the number of scans for generating the signal strength pattern of the electronic device 101 may be configured (or varied) based on at least one of the operating frequencies of the external electronic devices 212, 222, and/or 232, a reliability level of location information required by the electronic device 101, or a radio resource (e.g., time resource) allocated for scanning by the electronic device 101. For example, the signal strength pattern of the electronic device 101 may be generated based on an average value of the quality of signals received from the external electronic devices 212, 222, and/or 232 identified based on the results of the multiple scans.

According to an embodiment, the processor 300 may identify (or estimate) a location of the electronic device 101 within the designated space 200, based on the signal strength pattern of the electronic device 101 and the signal strength pattern of the external electronic devices 212, 222, and/or 232. For example, the processor 300 may identify a similarity between the signal strength pattern of the electronic device 101 and the signal strength pattern of the external electronic device 212, 222, or 232. For example, the similarity may indicate a degree of similarity between the signal strength pattern of the electronic device 101 and the signal strength pattern of the external electronic device 212, 222, or 232. For example, when the electronic device 101 fails to receive a signal of at least one external electronic device (e.g., the external electronic device 3232) among the external electronic devices 212, 222, and/or 232 disposed within the designated space 200, the similarity may indicate a degree of similarity between the signal strength pattern of the electronic device 101 and a signal strength pattern formed by the remaining external electronic devices 212 and 222, excluding an external electronic device (e.g., the external electronic device 3232) from which the electronic device 101 fails to receive a signal, among signal strength patterns of the respective external electronic devices 212, 222, or 232.

For example, the processor 300 may identify whether the external electronic device 212, 222, or 232 satisfying a designated similarity condition exists among the external electronic devices 212, 222, and/or 232. For example, the external electronic device satisfying the designated similarity condition may include an external electronic device for which a similarity between the signal strength pattern of the external electronic device 212, 222, or 232 and the signal strength pattern of the electronic device 101 is equal to or greater than a designated reference similarity.

For example, the processor 300 may determine, as an area in which the electronic device 101 is located, an area 210, 220, or 230 in which the external electronic device 212, 222, or 232 having the highest similarity to the signal strength pattern of the electronic device 101 among the external electronic devices 212, 222, or 232 satisfying the designated similarity condition is disposed. For example, when the external electronic device 212, 222, or 232 satisfying the designated similarity condition does not exist, the processor 300 may determine that location estimation of the electronic device 101 within the designated space 200 has failed. For example, a state in which a designated similarity selection condition is not satisfied may include a state in which there is no external electronic device 212, 222, and/or 232 for which a similarity between the signal strength pattern of the external electronic device 212, 222, or 232 and the signal strength pattern of the electronic device 101 is greater than or equal to the designated reference similarity.

For example, the processor 300 may identify a valid device of the area 210, 220, or 230 in which the external electronic device 212, 222, or 232 having the highest similarity to the signal strength pattern of the electronic device 101 is disposed. For example, when it is determined that a signal of the valid device has been received, the processor 300 may determine, as an area in which the electronic device 101 is located, the area 210, 220, or 230 in which the external electronic device 212, 222, or 232 having the highest similarity to the signal strength pattern of the electronic device 101 is disposed. For example, when it is determined that the signal of the valid device has not been received, the processor 300 may determine that location estimation of the electronic device 101 within the designated space 200 has failed. For example, a valid device of a specific area 210, 220, or 230 may include at least one external electronic device identified to be disposed in the specific area 210, 220, or 230 within the designated space 200. For example, a state in which it is determined that a signal of a valid device has been received may include a state in which the electronic device 101 has received a signal having a strength greater than or equal to a designated second reference strength from the valid device.

For example, the processor 300 may control an output device of the electronic device 101 to output information related to the failure of the location estimation of the electronic device 101. For example, the output device of the electronic device 101 may include at least one of a display, a speaker, a vibration module, or an indicator.

According to an embodiment, the communication circuit 310 may support wireless communication of the electronic device 101 and an external electronic device (e.g., the external electronic devices 212, 222, and/or 232 of FIG. 2).

According to an embodiment, the memory 320 may store various data used by at least one component (e.g., the processor 300 or the communication circuit 310) of the electronic device 101. For example, the memory 320 may store various instructions which may be executed through the processor 300.

According to an embodiment, an external electronic device 212 may include at least one of a processor (e.g., including processing circuitry) 330, a communication circuit (or communication circuitry) 340, and/or a memory 350. For example, the processor 330 may be substantially the same as the processor 120 of FIG. 1 or may be included in the processor 120 and thus a repeated description may not be provided here. The communication circuit 340 may be substantially the same as the wireless communication module 192 of FIG. 1 or may be included in the wireless communication module 192. The memory 350 may be substantially the same as the memory 130 of FIG. 1 or may be included in the memory 130. For example, the processor 330 may include at least one of an application processor, a communication processor, or a sensor hub processor. For example, the processor 330 may be operatively, functionally, and/or electrically connected to at least one of the communication circuit 340 or the memory 350. For example, the processor 330 may include at least one processor including processing circuitry.

According to an embodiment, when the external electronic device 1212 is registered with an IoT function, the processor 330 may control the communication circuit 340 to register, with the IoT function, at least one of information related to a location where the external electronic device 1212 is disposed or an operating frequency. For example, the IoT function may be a node for controlling the IoT function of the electronic device 101, and may be configured by a software or a separate hardware device (e.g., a server).

According to an embodiment, the processor 330 may generate a signal strength pattern 214 of the external electronic device 1212 in a state of being disposed within the designated space 200. For example, when an event related to a signal strength pattern occurs, the processor 330 may identify the quality of a signal received from the external electronic devices 212, 222, and/or 232 disposed within the designated space 200. The processor 330 may generate the signal strength pattern 214 of the external electronic device 1212, based on the quality of the signal received from the external electronic devices 212, 222, and/or 232. For example, the signal strength pattern 214 may include a set of qualities of signals (e.g., signal strength) received from the external electronic devices 212, 222, and/or 232 determined to be disposed in the designated space 200 by the external electronic device 1212. For example, a signal quality may include an average value of signal qualities identified (or measured) for a designated time, or a most recently identified (or measured) signal quality. For example, the signal quality may include at least one of RSSI, RSRQ, RSRP, SNR, SINR, QoS, or BER. For example, the event related to the signal strength pattern may occur based on arrival of a designated first period, execution of an application program or function related to generation of a signal strength pattern, or reception of a control signal related to generation of a signal strength pattern. For example, the designated first period may indicate a period configured to generate a signal strength pattern by the external electronic device 1212.

According to an embodiment, the processor 330 may control the communication circuit 340 to transmit information related to the signal strength pattern 214 of the external electronic device 1212 to the electronic device 101 located in the designated space 200. For example, when an event related to sharing of a signal strength pattern occurs, the processor 330 may control the communication circuit 340 to transmit, to the electronic device 101, information related to the signal strength pattern 214 of the external electronic device 1212. For example, the event related to sharing of the signal strength pattern may occur based on arrival of a designated second period, execution of an application program or function related to sharing of a signal strength pattern, or reception of a control signal related to entry of the electronic device 101 into the designated space 200. For example, the designated second period is a period indicating a time point for sharing of the signal strength pattern 214 by the external electronic device 1212 and may be configured to be the same as or longer than the designated first period. For example, the information related to the signal strength pattern 214 may be transmitted based on a short-range communication scheme including at least one of a wireless LAN (e.g., Wi-Fi), Bluetooth (or BLE), or UWB.

According to an embodiment, when a request signal related to location estimation is received from the electronic device 101, the processor 330 may control the communication circuit 340 to transmit a response signal corresponding to the request signal related to location estimation.

According to an embodiment, the communication circuit 340 may support wireless communication of the external electronic devices 212, 222, and/or 232 and wireless communication of the electronic device 101 and the external electronic device 1212.

According to an embodiment, the memory 350 may store various data used by at least one component (e.g., the processor 330 or the communication circuit 340) of the external electronic device 1212. For example, the memory 350 may store various instructions which may be executed individually or collectively through the processor 330 (e.g., at least one processor).

According to an example embodiment, an electronic device (e.g., the electronic device 101 of FIG. 1, FIG. 2, or FIG. 3) may include communication circuitry (e.g., the wireless communication module 192 of FIG. 1 or the communication circuit 310 of FIG. 3), at least one processor (e.g., the processor 120 of FIG. 1 or the processor 300 of FIG. 3), including processing circuitry, operationally connected to the communication circuit, and memory (e.g., the memory 130 of FIG. 1 or the memory 320 of FIG. 3) storing instructions. According to an embodiment, the instructions, when executed by the at least one processor individually or collectively, cause the electronic device to identify information related to first signal strength patterns of multiple external electronic devices (e.g., the external electronic devices 212, 222, and/or 232 of FIG. 2) disposed within a designated space (the designated space 200 of FIG. 2). According to an embodiment, the instructions, when executed by the at least one processor individually or collectively, cause the electronic device to generate a second signal strength pattern of the electronic device through scanning related to operating frequencies of the multiple external electronic devices. According to an embodiment, the instructions, when executed by the at least one processor individually or collectively, cause the electronic device to, based on a signal strength pattern corresponding to the second signal strength pattern existing among the first signal strength patterns, identify an external electronic device having the signal strength pattern corresponding to the second signal strength pattern. According to an embodiment, the instructions, when executed by the at least one processor individually or collectively, cause the electronic device to identify a location of the electronic device, based on a location at which the external electronic device is disposed within a designated space.

According to an example embodiment, the instructions, when executed by the at least one processor individually or collectively, cause the electronic device to identify operating frequencies of multiple external electronic devices. According to an embodiment, the instructions, when executed by the at least one processor individually or collectively, cause the electronic device to transmit a request signal related to location estimation, based on the operating frequencies of the multiple external electronic devices. According to an embodiment, the instructions, when executed by the at least one processor individually or collectively, cause the electronic device to, when a response signal corresponding to the request signal is received from at least a part of the multiple external electronic devices, generate a second signal strength pattern, based on a received signal strength of the response signal.

According to an example embodiment, the operating frequencies of the multiple external electronic devices may be acquired from the multiple external electronic devices or a separate server.

According to an example embodiment, the instructions, when executed by the at least one processor individually or collectively, cause the electronic device to perform scanning related to the operating frequencies of the multiple external electronic devices a designated number of times. According to an embodiment, the instructions, when executed by the at least one processor individually or collectively, cause the electronic device to generate a second signal strength pattern, based on a result of the scanning performed the designated number of times.

According to an example embodiment, the instructions, when executed by the at least one processor individually or collectively, cause the electronic device to identify an average value of a reception strength of the response signal, based on the result of the scanning performed the designated number of times. According to an embodiment, the instructions, when executed by the at least one processor individually or collectively, cause the electronic device to generate a second signal strength pattern, based on the average value of the reception strength of the response signal.

According to an example embodiment, the designated number of times may be configured based on at least one of the operating frequencies of the multiple external electronic devices, a reliability level of location information required by the electronic device, or the size of a radio resource allocated for scanning by the electronic device.

According to an example embodiment, the instructions, when executed by the at least one processor individually or collectively, cause the electronic device to identify at least one external electronic device among the multiple external electronic devices, satisfying a designated similarity condition for a similarity between the first signal strength pattern and the second signal strength pattern. According to an embodiment, the instructions, when executed by the at least one processor individually or collectively, cause the electronic device to identify an external electronic device among the at least one external electronic device satisfying the designated similarity condition, wherein the first signal strength pattern of the identified external electronic device has a highest similarity to the second signal strength pattern. According to an embodiment, the instructions, when executed by the at least one processor individually or collectively, cause the electronic device to determine that the electronic device is located in an area in which the external electronic device having the first signal strength pattern having the highest similarity to the second signal strength pattern is disposed within a designated space.

According to an example embodiment, the instructions, when executed by the at least one processor individually or collectively, cause the electronic device to, when the external electronic device satisfying the designated similarity condition does not exist, determine that location estimation of the electronic device has failed.

According to an example embodiment, the instructions, when executed by the at least one processor individually or collectively, cause the electronic device to identify a valid device of the area in which the external electronic device having the first signal strength pattern having the highest similarity to the second signal strength pattern is disposed within the designated space. According to an embodiment, the instructions, when executed by the at least one processor individually or collectively, cause the electronic device to, when a signal is acquired from the valid device, determine that the electronic device is located in the area in which the external electronic device having the first signal strength pattern having the highest similarity to the second signal strength pattern is disposed within the designated space.

According to an example embodiment, the instructions, when executed by the at least one processor individually or collectively, cause the electronic device to, when a signal is not acquired from the valid device, determine that location estimation of the electronic device has failed.

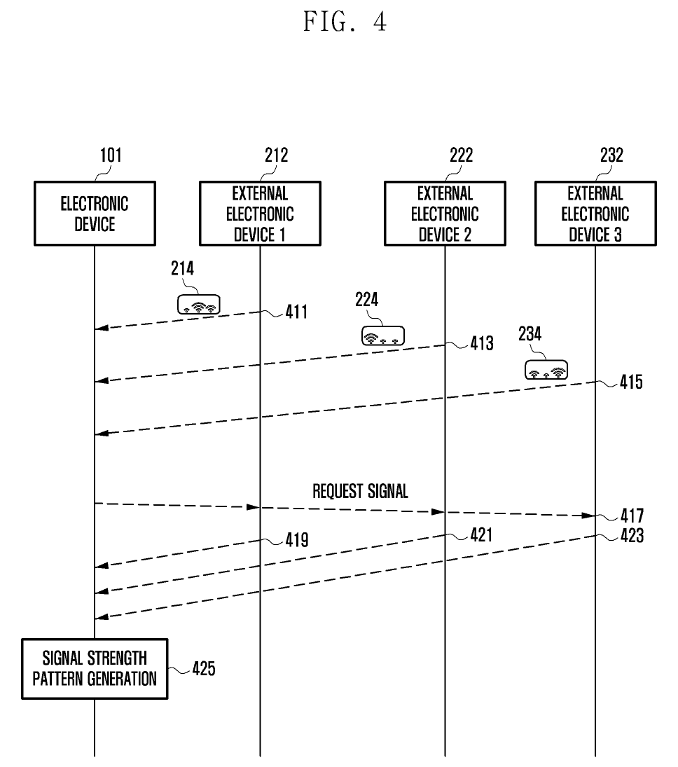

FIG. 4 is a signal flow diagram illustrating example operations for identifying a location of an electronic device within a designated space by the electronic device according to various example embodiments.

According to an embodiment referring to FIG. 4, external electronic devices 212, 222, and/or 232 disposed in a designated space 200 may generate a signal strength pattern 214, 224, or 234 of each external electronic device 212, 222, or 232. For example, the signal strength pattern 214, 224, or 234 of each external electronic device 212, 222, or 232 may include a set of qualities of signals (e.g., signal strength) received from the external electronic devices 212, 222, and/or 232 determined to be disposed in the designated space 200 in which each external electronic device 212, 222, or 232 is disposed. For example, a signal quality may include an average value of signal qualities identified (or measured) for a designated time, or a most recently identified (or measured) signal quality.

According to an embodiment, the external electronic devices 212, 222, and/or 232 may transmit information related to the signal strength pattern 214, 224, or 234 of each external electronic device 212, 222, or 232 to an electronic device 101 located in the designated space 200 (e.g., operations 411, 413, and 415). For example, the external electronic device 1212 may transmit information related to the signal strength pattern 214 of the external electronic device 1212 to the electronic device 101, based on occurrence of an event related to sharing of a signal strength pattern (e.g., operation 411). The external electronic device 2222 may transmit information related to the signal strength pattern 224 of the external electronic device 2222 to the electronic device 101, based on the occurrence of the event related to sharing of the signal strength pattern (e.g., operation 413). The external electronic device 3232 may transmit information related to the signal strength pattern 234 of the external electronic device 3232 to the electronic device 101, based on the occurrence of the event related to sharing of the signal strength pattern (e.g., operation 415). For example, the event related to sharing of the signal strength pattern may occur independently or identically for each external electronic device 212, 222, or 232. For example, the event related to sharing of the signal strength pattern may occur based on arrival of a designated second period, execution of an application program or function related to sharing of a signal strength pattern, or reception of a control signal related to entry of the electronic device 101 into the designated space 200. For example, the designated second period is a period indicating a time point for sharing of the signal strength pattern 214, 224, or 234 by the external electronic device 212, 222, or 232 and may be configured to be the same as or longer than a designated first period. For example, the information related to the signal strength pattern 214, 224, or 234 may be transmitted based on a short-range communication scheme including at least one of a wireless LAN (e.g., Wi-Fi), Bluetooth (or BLE), or UWB.

According to an embodiment, in case of entering the designated space 200, the electronic device 101 may identify the signal strength pattern 214, 224, and/or 234 of the external electronic devices 212, 222, and/or 232 disposed in the designated space 200 (e.g., operations 411, 413, and 415).

According to an embodiment, when an event related to location estimation occurs within the designated space 200, the electronic device 101 may transmit (or broadcast) a request signal related to location estimation (e.g., operation 417). For example, the request signal related to location estimation may be transmitted through operating frequencies of the external electronic devices 212, 222, and/or 232 disposed within the designated space 200.

According to an embodiment, when the external electronic devices 212, 222, and/or 232 receive the request signal related to location estimation, the external electronic devices 212, 222, and/or 232 may transmit a response signal corresponding to the request signal related to location estimation (e.g., operations 419, 421, and 423).

According to an embodiment, the electronic device 101 may generate a signal strength pattern of the electronic device 101, based on a signal quality of the response signal corresponding to the request signal related to location estimation (e.g., operation 425). For example, the electronic device 101 may generate a signal strength pattern, based on results of multiple scans related to the operating frequencies of the external electronic devices 212, 222 and/or 232. For example, the signal strength pattern may be generated based on an average value of the quality of signals received from the external electronic devices 212, 222, and/or 232 identified based on the results of the multiple scans.

According to an embodiment, the electronic device 101 may identify (or estimate) a location of the electronic device 101 within the designated space 200, based on the signal strength pattern of the electronic device 101 and the signal strength pattern of the external electronic devices 212, 222, and/or 232.

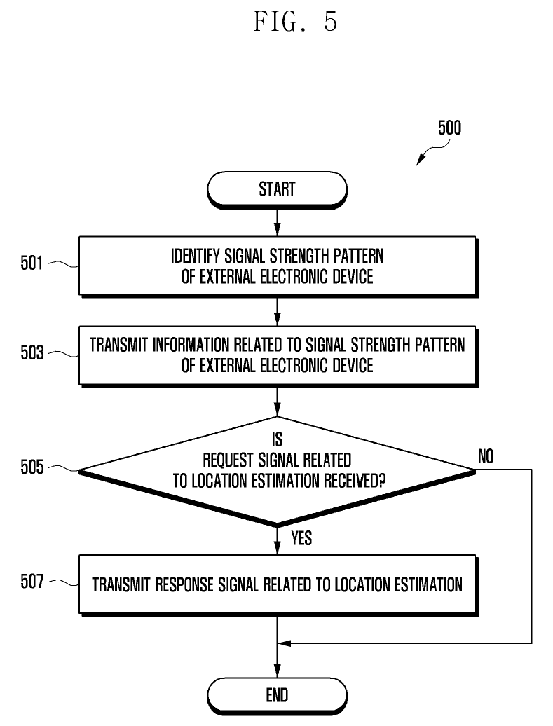

FIG. 5 is a flowchart 500 illustrating example operations for sharing information related to a signal strength pattern by an external electronic device according to various example embodiments. In the following example, each operation may be performed sequentially, but is not necessarily performed sequentially. For example, the order of each operation may be changed, and at least two operations may be performed in parallel. For example, an external electronic device of FIG. 5 may be the external electronic device 1212 of FIG. 1, FIG. 2, or FIG. 3.

According to an embodiment referring to FIG. 5, an external electronic device (e.g., the external electronic device 212, 222, or 232 of FIG. 2) or a processor (e.g., the processor 120 of FIG. 1 or the processor 330 of FIG. 3) of the external electronic device 212, 222, or 232 may identify (or generate) a signal strength pattern 214, 224, or 234 of the external electronic device 212, 222, or 232 in operation 501. For example, the signal strength pattern 214, 224, or 234 of the external electronic device 212, 222, or 232 may include a set of qualities of signals (e.g., signal strength) received from the external electronic devices 212, 222, and/or 232 determined to be disposed in a designated space 200 in which the external electronic device 212, 222, or 232 is disposed. For example, a signal quality may include an average value of signal qualities identified (or measured) for a designated time, or a most recently identified (or measured) signal quality.

According to an embodiment, the external electronic device (e.g., the external electronic device 212, 222, or 232) or the processor (e.g., the processor 120 or 330) may transmit information related to the signal strength pattern 214, 224, or 234 of the external electronic devices 212, 222, or 232 to the electronic device 101 located in the designated space 200, in operation 503. For example, the processor 330 may control a communication circuit 340 to transmit, to the electronic device 101, information related to the signal strength pattern 214, 224, or 234 of the external electronic device 212, 222, or 232, based on occurrence of an event related to sharing of a signal strength pattern. For example, the event related to sharing of the signal strength pattern may occur independently or identically for each external electronic device 212, 222, or 232. For example, the event related to sharing of the signal strength pattern may occur based on arrival of a designated second period, execution of an application program or function related to sharing of a signal strength pattern, or reception of a control signal related to entry of the electronic device 101 into the designated space 200. For example, the information related to the signal strength pattern 214, 224, or 234 may be transmitted based on a short-range communication scheme including at least one of a wireless LAN (e.g., Wi-Fi), Bluetooth (or BLE), or UWB.

According to an embodiment, the external electronic device (e.g., the external electronic device 212, 222, or 232) or the processor (e.g., the processor 120 or 330) may identify whether a request signal related to location estimation is received, in operation 505. For example, the processor 330 may control the communication circuit 340 to continuously or periodically identify whether the request signal related to location estimation is received. For example, the request signal related to location estimation may be a signal for generating a response of the external electronic device 212, 222, or 232, and may include at least one of a probe request signal or a domain name system (DNS) query.

According to an embodiment, when the request signal related to location estimation is not received (e.g., “No” in operation 505), the external electronic device (e.g., the external electronic device 212, 222, or 232) or the processor (e.g., the processor 120 or 330) may terminate sharing information related to a signal strength pattern.

According to an embodiment, when the request signal related to location estimation is received (e.g., “Yes” in operation 505), the external electronic device (e.g., the external electronic device 212, 222, or 232) or the processor (e.g., the processor 120 or 330) may transmit (or broadcast) a response signal corresponding to the request signal related to location estimation in operation 507.

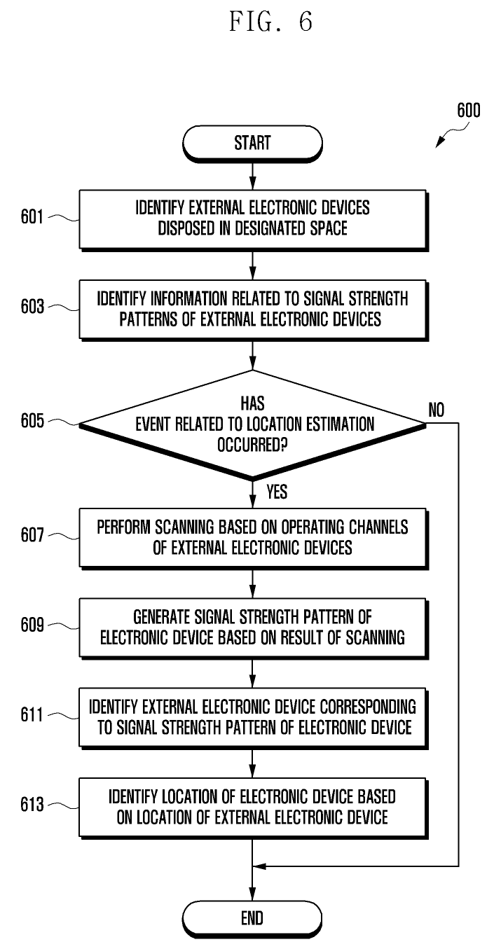

FIG. 6 is a flowchart 600 illustrating example operations for identifying a location of an electronic device based on a signal strength pattern of an external electronic device by the electronic device according to various example embodiments. In the following example, each operation may be performed sequentially, but is not necessarily performed sequentially. For example, the order of each operation may be changed, and at least two operations may be performed in parallel. As an example, an electronic device of FIG. 6 may be the electronic device 101 of FIG. 1, FIG. 2, or FIG. 3.

According to an embodiment referring to FIG. 6, an electronic device (e.g., the electronic device 101 of FIG. 1, FIG. 2, or FIG. 3) or a processor (e.g., the processor 120 of FIG. 1 or the processor 300 of FIG. 3) of the electronic device 101 may identify external electronic devices (e.g., the external electronic devices 212, 222, and/or 232 of FIG. 2) disposed in a designated space (e.g., the designated space 200 of FIG. 2), in operation 601. For example, when the electronic device 101 enters the designated space 200, the processor 300 may identify information related to the external electronic devices 212, 222, and/or 232 disposed in the designated space 200. For example, when a signal having a strength equal to or greater than a designated first reference strength is received from the external electronic devices 212, 222, and/or 232 disposed in the designated space 200, the processor 300 may determine that the electronic device 101 has entered the designated space 200. For example, the processor 300 may identify entry into the designated space 200 of the electronic device 101, based on a location estimation scheme (e.g., a satellite navigation system). For example, the information related to the external electronic devices 212, 222, and/or 232 may include at least one of identification information of the external electronic devices 212, 222, and/or 232 or information related to an operating frequency. For example, the information related to the external electronic devices 212, 222, and/or 232 may be acquired from the respective external electronic devices 212, 222, and/or 232 or a node (e.g., a server) which controls an IoT function.

According to an embodiment, the electronic device (e.g., the electronic device 101) or the processor (e.g., the processor 120 or 300) may identify information related to a signal strength pattern of each external electronic device disposed in the designated space, in operation 603.

According to an embodiment, the electronic device (e.g., the electronic device 101) or the processor (e.g., the processor 120 or 300) may identify whether an event related to location estimation occurs in a state of being located in the designated space 200, in operation 605. For example, the event related to location estimation may occur based on execution of an application program or function related to location estimation, reception of an input (e.g., a touch input, a gesture input, or a voice input) related to location estimation, or reception of a control signal related to location estimation.

According to an embodiment, when the event related to location estimation does not occur (e.g., “No” in operation 605), the electronic device (e.g., the electronic device 101) or the processor (e.g., the processor 120 or 300) may terminate identifying a location of the electronic device.

According to an embodiment, when the event related to location estimation occurs (e.g., “Yes” in operation 605), the electronic device (e.g., the electronic device 101) or the processor (e.g., the processor 120 or 300) may perform scanning related to operating frequencies of the external electronic devices 212, 222, and/or 232 disposed within the designated space 200, in operation 607. For example, a signal received by the electronic device 101 from the external electronic devices 212, 222, and/or 232 may have a signal strength (or amplitude) that continuously varies due to a combination of phases of signals received through multiple paths. The processor 300 may control a communication circuit 310 to perform the scanning related to the operating frequencies of the external electronic devices 212, 222, and/or 232 disposed within the designated space 200, in order to reduce a time consumed by the scan. For example, the scanning may include a series of operations of transmitting a request signal related to location estimation and receiving a response signal corresponding to the request signal to identify a signal quality. For example, the request signal related to location estimation may be a signal for generating a response of the external electronic device 212, 222, or 232, and may include at least one of a probe request signal or a domain name system (DNS) query.

For example, when the external electronic devices 212, 222, and/or 232 use a wireless LAN communication scheme, transmission of a response signal may be delayed according to a traffic situation of a wireless resource by a random access-based medium access control (e.g., carrier sense multiple access (CSMA)/collision avoidance (CA)). In order to prevent and/or reduce an error from occurring in a signal strength pattern of the electronic device 101 due to omission of a response signal caused by delay, the processor 300 may control the communication circuit 310 to perform multiple scans. For example, the number of scans may be fixed to a designated number. For example, the number of scans may be configured (or varied) based on at least one of the operating frequencies of the external electronic devices 212, 222, and/or 232, a reliability level of location information required by the electronic device 101, or a radio resource (e.g., time resource) allocated for scanning by the electronic device 101.

According to an embodiment, the electronic device (e.g., the electronic device 101) or the processor (e.g., the processor 120 or 300) may generate a signal strength pattern of the electronic device 101, based on a result of the scanning related to the operating frequencies of the external electronic devices 212, 222, and/or 232, in operation 609. For example, the signal strength pattern of the electronic device 101 may be generated based on an average value of the quality of signals received from the external electronic devices 212, 222, and/or 232 identified based on results of the multiple scans.

According to an embodiment, the electronic device (e.g., the electronic device 101) or the processor (e.g., the processor 120 or 300) may identify an external electronic device corresponding to the signal strength pattern of the electronic device 101 in operation 611. For example, the processor 300 may identify a similarity between the signal strength pattern of the electronic device 101 and the signal strength pattern of the external electronic device 212, 222, or 232. For example, the similarity may indicate a degree of similarity between the signal strength pattern of the electronic device 101 and the signal strength pattern of the external electronic device 212, 222, or 232.

For example, the processor 300 may identify whether the external electronic device 212, 222, or 232 satisfying a designated similarity condition exists among the external electronic devices 212, 222, and/or 232. For example, the external electronic device satisfying the designated similarity condition may include an external electronic device for which a similarity between the signal strength pattern of the external electronic device 212, 222, or 232 and the signal strength pattern of the electronic device 101 is equal to or greater than a designated reference similarity.

For example, the processor 300 may select the external electronic device 212, 222, or 232 having the highest similarity to the signal strength pattern of the electronic device 101 among the at least one external electronic device 212, 222, and/or 232 satisfying the designated similarity condition.

According to an embodiment, the electronic device (e.g., the electronic device 101) or the processor (e.g., the processor 120 or 300) may identify a location of the electronic device 101, based on a location of the external electronic device corresponding to the signal strength pattern of the electronic device 101, in operation 613. For example, the processor 300 may determine that the electronic device 101 is located in an area (e.g., the first area 210, the second area 220, or the third area 230 of FIG. 2) where the external electronic device 212, 222, or 232 corresponding to the signal strength pattern of the electronic device 101 is located.

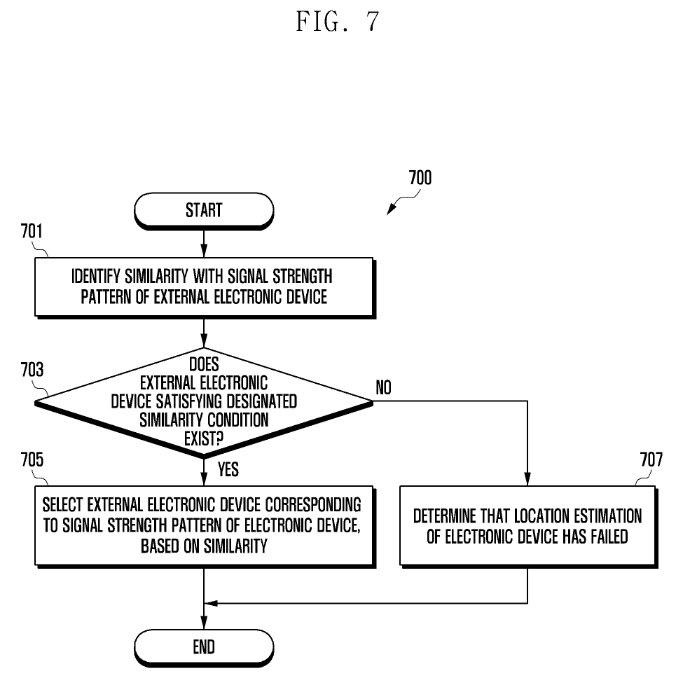

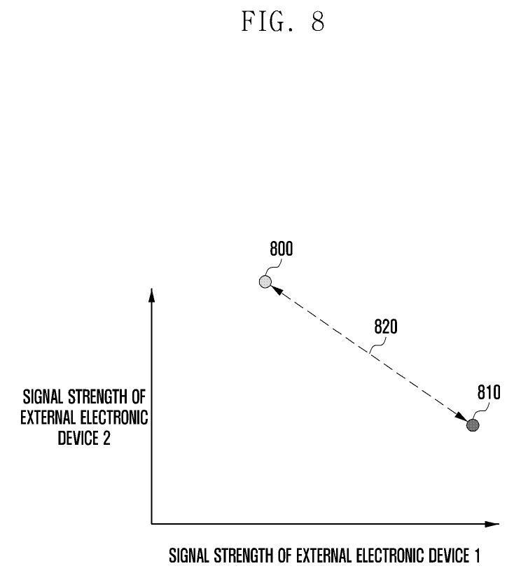

FIG. 7 is a flowchart 700 illustrating example operations for selecting an external electronic device based on a similarity of signal strength patterns by an electronic device according to various example embodiments. For example, at least a part of FIG. 7 may include detailed operations of operation 611 of FIG. 6. In the following example, each operation may be performed sequentially, but is not necessarily performed sequentially. For example, the order of each operation may be changed, and at least two operations may be performed in parallel. As an example, an electronic device of FIG. 7 may be the electronic device 101 of FIG. 1, FIG. 2, or FIG. 3. As an example, at least a part of FIG. 7 may be described with reference to FIG. 8. FIG. 8 is a graph illustrating an example for identifying a similarity of signal strength patterns by an electronic device according to various example embodiments.

According to an embodiment referring to FIGS. 7 and 8, when an electronic device (e.g., the electronic device 101 of FIG. 1, FIG. 2, or FIG. 3) or a processor (e.g., the processor 120 of FIG. 1 or the processor 300 of FIG. 3) of the electronic device 101 has generated a signal strength pattern of the electronic device 101 (e.g., operation 609 in FIG. 6), the electronic device or the processor may identify a similarity between the signal strength pattern of the electronic device 101 and a signal strength pattern of each external electronic device 212, 222, or 232 disposed in a designated space 200, in operation 701. For example, as illustrated in FIG. 8, when the electronic device 101 receives signals of external electronic device 1212 and external electronic device 2222, the processor 300 may generate a signal strength pattern 800 of the electronic device 101, based on signal strengths of the external electronic device 1212 and the external electronic device 2222. The processor 300 may estimate, from signal strength patterns of respective external electronic devices 212, 222, or 232, a similarity 820 between the signal strength pattern 800 of the electronic device 101 and a signal strength pattern 810 based on the remaining external electronic devices 212 and 222, excluding an external electronic device (e.g., the external electronic device 3232) from which the electronic device 101 fails to receive a signal. For example, when the electronic device 101 receives signals from three external electronic devices 212, 222, and 232, the processor 300 may estimate a similarity between the signal strength pattern of the electronic device 101 and the signal strength pattern of each of the external electronic devices 212, 222, and 232, in the form of three dimensions by the three external electronic devices 212, 222, and 232. When the electronic device 101 receives signals from two external electronic devices 212 and 222 except for the external electronic device 3232, the processor 300 may estimate, as illustrated in FIG. 8, the similarity 820 between the signal strength pattern 800 of the electronic device 101 and the signal strength pattern 810 of each of the external electronic devices 212 and 222 in a two-dimensional form by the two external electronic devices 212 and 222.

According to an embodiment, the electronic device (e.g., the electronic device 101) or the processor (e.g., the processor 120 or 300) may identify whether at least one external electronic device satisfying a designated similarity condition exists among the external electronic devices 212, 222, and/or 232 disposed in the designated space 200, in operation 703. For example, the external electronic device satisfying the designated similarity condition may include an external electronic device for which a similarity between the signal strength pattern of the external electronic device 212, 222, or 232 and the signal strength pattern of the electronic device 101 is equal to or greater than a designated reference similarity.

According to an embodiment, when at least one external electronic device satisfying the designated similarity condition exists (e.g., “Yes” in operation 703), the electronic device (e.g., the electronic device 101) or the processor (e.g., the processor 120 or 300) may select an external electronic device corresponding to the signal strength pattern of the electronic device 101 among the at least one external electronic device satisfying the designated similarity condition, in operation 705. For example, when there is a single external electronic device satisfying the designated similarity condition, the processor 300 may select the external electronic device satisfying the designated similarity condition as the external electronic device corresponding to the signal strength pattern of the electronic device 101. For example, when multiple external electronic devices satisfying the designated similarity condition exist, the processor 300 may select an external electronic device having the largest similarity to the signal strength pattern of the electronic device 101 among the external electronic devices satisfying the designated similarity condition. For example, the external electronic device having the greatest similarity to the signal strength pattern of the electronic device 101 may include an external electronic device having a signal strength pattern determined to be most similar to the signal strength pattern of the electronic device 101.

For example, the processor 300 may determine that the electronic device 101 is located in an area (e.g., the first area 210, the second area 220, or the third area 230 of FIG. 2) where the external electronic device 212, 222, or 232 corresponding to the signal strength pattern of the electronic device 101 is located.

According to an embodiment, when at least one external electronic device satisfying the designated similarity condition does not exist (e.g., “No” in operation 703), the electronic device (e.g., the electronic device 101) or the processor (e.g., the processor 120 or 300) may determine that location estimation of the electronic device 101 has failed, in operation 707.

According to an embodiment, when it is determined that the location estimation of the electronic device 101 has failed, the electronic device 101 may output information related to the failure of the location estimation of the electronic device 101. For example, the information related to the failure of the location estimation of the electronic device 101 may be output through at least one of a display, a speaker, a vibration module, or an indicator.

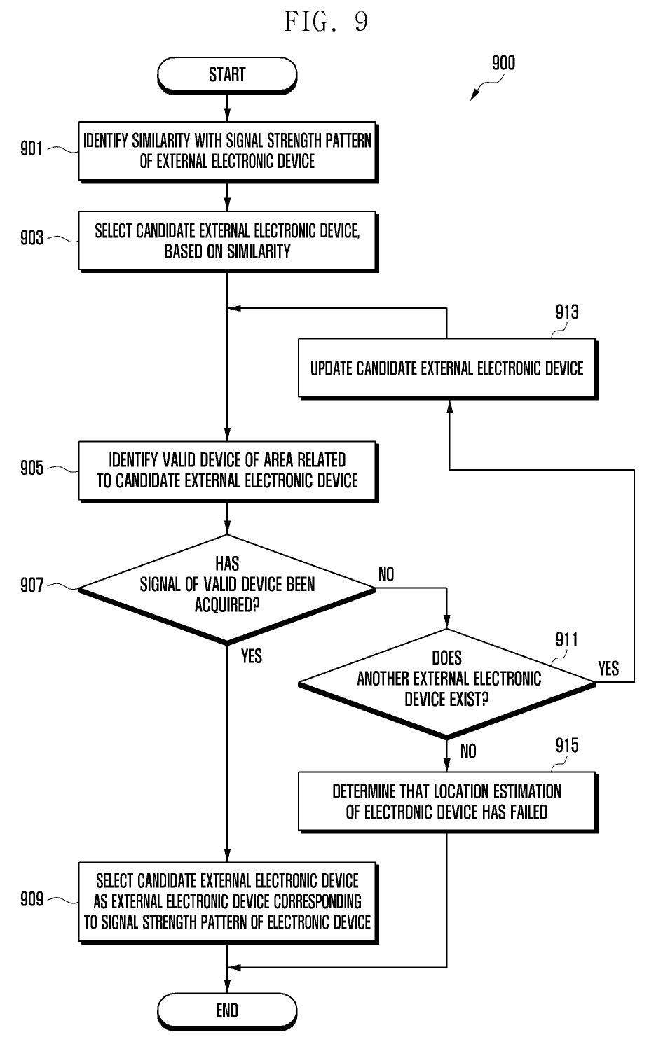

FIG. 9 is a flowchart 900 illustrating example operations for identifying a location of an electronic device based on information related to a valid device by an electronic device according to various example embodiments. For example, at least a part of FIG. 9 may include detailed operations of operation 611 of FIG. 6. In the following example, each operation may be performed sequentially, but is not necessarily performed sequentially. For example, the order of each operation may be changed, and at least two operations may be performed in parallel. As an example, an electronic device of FIG. 9 may be the electronic device 101 of FIG. 1, FIG. 2, or FIG. 3.

According to an embodiment referring to FIG. 9, when an electronic device (e.g., the electronic device 101 of FIG. 1, FIG. 2, or FIG. 3) or a processor (e.g., the processor 120 of FIG. 1 or the processor 300 of FIG. 3) of the electronic device 101 has generated a signal strength pattern of the electronic device 101 (e.g., operation 609 in FIG. 6), the electronic device or the processor may identify a similarity between the signal strength pattern of the electronic device 101 and a signal strength pattern of each external electronic device 212, 222, or 232 disposed in a designated space 200, in operation 901. For example, as illustrated in FIG. 8, when the electronic device 101 receives signals of external electronic device 1212 and external electronic device 2222, the processor 300 may generate a signal strength pattern 800 of the electronic device 101, based on signal strengths of the external electronic device 1212 and the external electronic device 2222. The processor 300 may estimate, from signal strength patterns of respective external electronic devices 212, 222, or 232, a similarity 820 between the signal strength pattern 800 of the electronic device 101 and a signal strength pattern 810 based on the remaining external electronic devices 212 and 222, excluding an external electronic device (e.g., the external electronic device 3232) from which the electronic device 101 fails to receive a signal.

According to an embodiment, the electronic device (e.g., the electronic device 101) or the processor (e.g., the processor 120 or 300) may select a candidate external electronic device among the external electronic devices 212, 222, and/or 232 disposed in the designated space 200, based on a similarity to the signal strength pattern of the electronic device 101, in operation 903. For example, the processor 300 may identify whether at least one external electronic device satisfying a designated similarity condition exists among the external electronic devices 212, 222, and/or 232 disposed in the designated space 200. For example, the external electronic device satisfying the designated similarity condition may include an external electronic device for which a similarity between the signal strength pattern of the external electronic device 212, 222, or 232 and the signal strength pattern of the electronic device 101 is equal to or greater than a designated reference similarity. For example, when at least one external electronic device satisfying the designated similarity condition exists, the processor 300 may select, as a candidate external electronic device, an external electronic device having the greatest similarity to a signal strength pattern of the electronic device 101 among the at least one external electronic device satisfying the designated similarity condition. For example, the external electronic device having the greatest similarity to the signal strength pattern of the electronic device 101 may include an external electronic device having a signal strength pattern determined to be most similar to the signal strength pattern of the electronic device 101.

For example, when the external electronic device satisfying the designated similarity condition does not exist, the processor 300 may determine that location estimation of the electronic device 101 has failed.

According to an embodiment, the electronic device (e.g., the electronic device 101) or the processor (e.g., the processor 120 or 300) may identify a valid device of an area related to the candidate external electronic device in operation 905. For example, when the external electronic device 1212 of FIG. 2 is configured as a candidate external electronic device, the processor 300 may identify a valid device of a first area 210 determined to be an area in which the external electronic device 1212 is disposed. For example, when the external electronic device 2222 of FIG. 2 is configured as a candidate external electronic device, the processor 300 may identify a valid device of a second area 220 determined to be an area in which the external electronic device 2222 is disposed. For example, when the external electronic device 3232 of FIG. 2 is configured as a candidate external electronic device, the processor 300 may identify a valid device of a third area 230 determined to be an area in which the external electronic device 3232 is disposed.

According to an embodiment, the electronic device (e.g., the electronic device 101) or the processor (e.g., the processor 120 or 300) may identify whether a signal of the valid device has been acquired when generating the signal strength pattern of the electronic device 101, in operation 907. For example, the processor 300 may identify whether strength information of a signal received from the valid device of the area related to the candidate external electronic device is included in the signal strength pattern of the electronic device 101. For example, when the strength information of the signal received from the valid device of the area related to the candidate external electronic device is included in the signal strength pattern of the electronic device 101, the processor 300 may determine that the signal of the valid device has been acquired. For example, when the strength information of the signal received from the valid device of the area related to the candidate external electronic device is not included in the signal strength pattern of the electronic device 101, the processor 300 may determine that the signal of the valid device has not been acquired. For example, when multiple valid devices are configured in the area related to the candidate external electronic device in the signal strength pattern of the electronic device 101, and strength information of a signal received from at least one valid device among the multiple valid devices is included, the processor 300 may determine that the signal of the valid device has been acquired.

According to an embodiment, when it is determined that the signal of the valid device has been acquired (e.g., “Yes” in operation 907), the electronic device (e.g., the electronic device 101) or the processor (e.g., the processor 120 or 300) may select the candidate external electronic device as an external electronic device corresponding to the signal strength pattern of the electronic device 101, in operation 909. For example, the processor 300 may determine that the electronic device 101 is located in an area (e.g., the first area 210, the second area 220, or the third area 230 of FIG. 2) where the candidate external electronic device 212, 222, or 232 is located.

According to an embodiment, when it is determined that the signal of the valid device has not been acquired (e.g., “No” in operation 907), the electronic device (e.g., the electronic device 101) or the processor (e.g., the processor 120 or 300) may identify whether another external electronic device selectable as the candidate external electronic device exists among the external electronic devices 212, 222, and/or 232 disposed in the designated space 200, in operation 911. For example, the other external electronic devices may include the remaining external electronic devices excluding the candidate external electronic device and the external electronic device that had been selected as the candidate external electronic device, among at least one external electronic device satisfying the designated similarity condition.

According to an embodiment, when it is determined that another external electronic device selectable as the candidate external electronic device exists (e.g., “Yes” in operation 911), the electronic device (e.g., the electronic device 101) or the processor (e.g., the processor 120 or 300) may update the candidate external electronic device in operation 913. For example, when one other external electronic device selectable as the candidate external electronic device exists, the processor 300 may select the other external electronic device as the candidate external electronic device. For example, when multiple other external electronic devices selectable as the candidate external electronic device exist, the processor 300 may select, among the other external electronic devices, an external electronic device having the greatest similarity to the signal strength pattern of the electronic device 101 as the candidate external electronic device.

For example, the processor 300 may identify the valid device of the area related to the candidate external electronic device (e.g., operation 905).

According to an embodiment, when it is determined that no other external electronic device selectable as the candidate external electronic device exists (e.g., “No” in operation 911), the electronic device (e.g., the electronic device 101) or the processor (e.g., the processor 120 or 300) may determine that location estimation of the electronic device 101 has failed, in operation 915.

According to an embodiment, when it is determined that the location estimation of the electronic device 101 has failed, the electronic device 101 may output information related to the failure of the location estimation of the electronic device 101. For example, the information related to the failure of the location estimation of the electronic device 101 may be output through at least one of a display, a speaker, a vibration module, or an indicator.

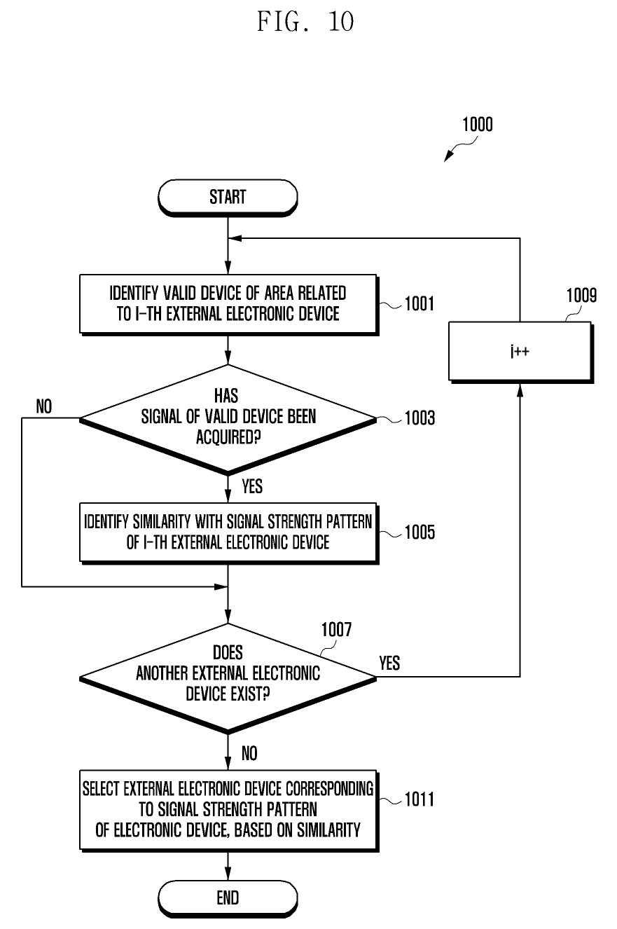

FIG. 10 is a flowchart 1000 illustrating example operations for identifying a location of an electronic device based on information related to a valid device by an electronic device according to various example embodiments. For example, at least a part of FIG. 10 may include detailed operations of operation 611 of FIG. 6. In the following example, each operation may be performed sequentially, but is not necessarily performed sequentially. For example, the order of each operation may be changed, and at least two operations may be performed in parallel. As an example, an electronic device of FIG. 10 may be the electronic device 101 of FIG. 1, FIG. 2, or FIG. 3.

According to an embodiment referring to FIG. 10, when an electronic device (e.g., the electronic device 101 of FIG. 1, FIG. 2, or FIG. 3) or a processor (e.g., the processor 120 of FIG. 1 or the processor 300 of FIG. 3) has generated a signal strength pattern of the electronic device 101 (e.g., operation 609 in FIG. 6), the electronic device or the processor may identify a valid device of an area related to an i-th external electronic device among external electronic devices 212, 222, and/or 232 disposed in a designated space 200, in operation 1001. For example, i may be an index for indicating the external electronic device disposed in the designated space 200, and may include an initial value of “0” or “1”. The valid device may include an external electronic device identified to be disposed in the specific area 210, 220, or 230 of the designated space 200.

According to an embodiment, the electronic device (e.g., the electronic device 101) or the processor (e.g., the processor 120 or 300) may identify whether a signal of the valid device has been acquired when generating the signal strength pattern of the electronic device 101, in operation 1003. For example, the processor 300 may identify whether strength information of a signal received from the valid device of the area related to the i-th external electronic device is included in the signal strength pattern of the electronic device 101. For example, when the strength information of the signal received from the valid device of the area related to the i-th external electronic device is included in the signal strength pattern of the electronic device 101, the processor 300 may determine that the signal of the valid device has been acquired. For example, when the strength information of the signal received from the valid device of the area related to the i-th external electronic device is not included in the signal strength pattern of the electronic device 101, the processor 300 may determine that the signal of the valid device has not been acquired. For example, when multiple valid devices are configured in the area related to the i-th external electronic device in the signal strength pattern of the electronic device 101, and strength information of a signal received from at least one valid device among the multiple valid devices is included, the processor 300 may determine that the signal of the valid device has been acquired. For example, a state in which it is determined that a signal of a valid device has been received may include a state in which the electronic device 101 has received a signal having a strength greater than or equal to a designated second reference strength from the valid device.

According to an embodiment, when it is determined that the signal of the valid device has not been acquired (e.g., “No” in operation 1003), the electronic device (e.g., the electronic device 101) or the processor (e.g., the processor 120 or 300) may identify whether another external electronic device for identifying a similarity with the signal strength pattern of the electronic device 101 exists, in operation 1007. For example, when it is determined that a signal has not been acquired from the valid device of the area related to the i-th external electronic device, the processor 300 may determine that the electronic device 101 is not located in the area related to the i-th external electronic device. The processor 300 may omit an operation of identifying a similarity between the signal strength pattern of the electronic device 101 and a signal strength pattern of the i-th external electronic device 212, 222, or 232, based on the determination that the electronic device 101 is not located in the area related to the i-th external electronic device.

According to an embodiment, when it is determined that the signal of the valid device has been acquired (e.g., “Yes” in operation 1003), the electronic device (e.g., the electronic device 101) or the processor (e.g., the processor 120 or 300) may identify a similarity between the signal strength pattern of the electronic device 101 and the signal strength pattern of the i-th external electronic device 212, 222, or 232, in operation 1005. For example, as illustrated in FIG. 8, when the electronic device 101 receives signals of external electronic device 1212 and external electronic device 2222, the processor 300 may generate a signal strength pattern 800 of the electronic device 101, based on signal strengths of the external electronic device 1212 and the external electronic device 2222. The processor 300 may estimate, from signal strength patterns of respective external electronic devices 212, 222, or 232, a similarity 820 between the signal strength pattern 800 of the electronic device 101 and a signal strength pattern 810 based on the remaining external electronic devices 212 and 222, excluding an external electronic device (e.g., the external electronic device 3232) from which the electronic device 101 fails to receive a signal.

According to an embodiment, the electronic device (e.g., the electronic device 101) or the processor (e.g., the processor 120 or 300) may identify whether another external electronic device for identifying a similarity with the signal strength pattern of the electronic device 101 exists, in operation 1007.

According to an embodiment, when another external electronic device for identifying a similarity with the signal strength pattern of the electronic device 101 exists (e.g., “Yes” in operation 1007), the electronic device (e.g., the electronic device 101) or the processor (e.g., the processor 120 or 300) may update an index (i) of the external electronic device in operation 1009 (e.g., i++).

According to an embodiment, when another external electronic device for identifying a similarity with the signal strength pattern of the electronic device 101 exists, the electronic device (e.g., the electronic device 101) or the processor (e.g., the processor 120 or 300) may repeatedly perform operations 1001 to 1009.

According to an embodiment, when another external electronic device for identifying a similarity with the signal strength pattern of the electronic device 101 does not exist (e.g., “No” in operation 1007), the electronic device (e.g., the electronic device 101) or the processor (e.g., the processor 120 or 300) may select an external electronic device corresponding to the signal strength pattern of the electronic device 101 from among at least one external electronic device for which a similarity with the signal strength pattern of the electronic device 101 has been identified, in operation 1011. For example, the processor 300 may identify whether at least one external electronic device for which a similarity with the signal strength pattern of the electronic device 101 has been identified exists among the external electronic devices 212, 222, and/or 232 disposed in the designated space 200. For example, when at least one external electronic device for which a similarity with the signal strength pattern of the electronic device 101 has been identified exists, the processor 300 may select an external electronic device having the greatest similarity to the signal strength pattern of the electronic device 101 as an external electronic device corresponding to the signal strength pattern of the electronic device 101. For example, the processor 300 may determine that the electronic device 101 is located in an area (e.g., the first area 210, the second area 220, or the third area 230 of FIG. 2) where the external electronic device 212, 222, or 232 having the greatest similarity to the signal strength pattern of the electronic device 101 is located.

For example, when an external electronic device for which a similarity with the signal strength pattern of the electronic device 101 has been identified does not exist, the processor 300 may determine that location estimation of the electronic device 101 has failed.

According to an embodiment, when it is determined that the location estimation of the electronic device 101 has failed, the electronic device 101 may output information related to the failure of the location estimation of the electronic device 101. For example, the information related to the failure of the location estimation of the electronic device 101 may be output through at least one of a display, a speaker, a vibration module, or an indicator.

According to an example embodiment, a method of operating an electronic device (e.g., the electronic device 101 of FIG. 1, FIG. 2, or FIG. 3) may include identifying information related to first signal strength patterns of multiple external electronic devices 212, 222, and/or 232 disposed within a designated space (the designated space 200 of FIG. 2). According to an embodiment, the method may include, through scanning related to operating frequencies of the multiple external electronic devices, generating a second signal strength pattern of the electronic device. According to an embodiment, the method may include, when a signal strength pattern corresponding to the second signal strength pattern exists among the first signal strength patterns, identifying an external electronic device having a signal strength pattern corresponding to the second signal strength pattern. According to an embodiment, the method of may include identifying a location of the electronic device, based on a location at which the external electronic device is disposed within the designated space.

According to an example embodiment, the generating of the second signal strength pattern may include identifying the operating frequencies of the multiple external electronic devices, transmitting a request signal related to location estimation, based on the operating frequencies, and when a response signal corresponding to the request signal is received from at least a part of the multiple external electronic devices, generating a second signal strength pattern, based on a received signal strength of the response signal.

According to an example embodiment, the generating of the second signal strength pattern may include performing scanning related to the operating frequencies of the multiple external electronic devices a designated number of times, and generating the second signal strength pattern, based on the result of the scanning performed the designated number of times.

According to an example embodiment, the generating of the second signal strength pattern may include identifying an average value of a reception strength of the response signal, based on the result of the scanning performed the designated number of times, and generating the second signal strength pattern, based on the average value of the reception strength of the response signal.

According to an example embodiment, the identifying of the external electronic device may include identifying at least one external electronic device among the multiple external electronic devices, satisfying a designated similarity condition for a similarity between the first signal strength pattern and the second signal strength pattern, and identifying, among the at least one external electronic device satisfying the designated similarity condition, an external electronic device having a first signal strength pattern having a highest similarity to the second signal strength pattern.

According to an example embodiment, the method may include, based on an external electronic device satisfying the designated similarity condition does not exist, determining that location estimation of the electronic device has failed.

According to an example embodiment, the identifying of the location of the electronic device may include identifying a valid device of an area where the external electronic device is disposed within the designated space, and when a signal is acquired from the valid device, determining that the electronic device is located in the area where the external electronic device is disposed within the designated space.

According to an example embodiment, the method may include, when a signal is not acquired from the valid device, determining that the location estimation of the electronic device has failed.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
communication circuitry;
at least one processor, comprising processing circuitry, operatively connected to the communication circuitry; and
memory storing instructions,
wherein the instructions, when executed by at least one processor individually and/or collectively, cause the electronic device to:
identify information related to first signal strength patterns of multiple external electronic devices disposed within a designated space;
generate a second signal strength pattern of the electronic device through scanning related to operating frequencies of the multiple external electronic devices;
based on a signal strength pattern corresponding to the second signal strength pattern existing among the first signal strength patterns, identify an external electronic device having the signal strength pattern corresponding to the second signal strength pattern; and
identify a location of the electronic device, based on a location at which the external electronic device is disposed within the designated space.

2. The electronic device of claim 1, wherein the instructions, when executed by at least one processor, individually and/or collectively, cause the electronic device to:
identify the operating frequencies of the multiple external electronic devices;
transmit a request signal related to location estimation, based on the identified operating frequencies; and
based on response signals corresponding to the request signal being received from at least some of the multiple external electronic devices, generate the second signal strength pattern, based on received signal strengths of the response signals.

3. The electronic device of claim 1, wherein the instructions, when executed by at least one processor, individually and/or collectively, cause the electronic device to:
perform the scanning related to the operating frequencies of the multiple external electronic devices a designated number of times; and
generate the second signal strength pattern, based on a result of the scanning performed the designated number of times.

4. The electronic device of claim 3, wherein the instructions, when executed by at least one processor, individually and/or collectively, cause the electronic device to:
identify an average value of reception strengths of the response signals, based on the result of the scanning performed the designated number of times; and
generate the second signal strength pattern, based on the average value of the reception strengths of the response signals.

5. The electronic device of claim 1, wherein the instructions, when executed by at least one processor, individually and/or collectively, cause the electronic device to:
identify at least one external electronic device among the multiple external electronic devices, satisfying a designated similarity condition for a similarity between the first signal strength pattern and the second signal strength pattern;
identify, among the identified at least one external electronic device, an external electronic device, wherein the first signal strength pattern of the identified external electronic device has a highest similarity to the second signal strength pattern; and
determine that the electronic device is located in an area in which the identified external electronic device is disposed within the designated space.

6. The electronic device of claim 5, wherein the instructions, when executed by at least one processor, individually and/or collectively, cause the electronic device to, based on an external electronic device satisfying the designated similarity condition not existing, determine that location estimation of the electronic device has failed.

7. The electronic device of claim 5, wherein the instructions, when executed by at least one processor, individually and/or collectively, cause the electronic device to:
identify a valid device in the area in which the identified external electronic device is disposed within the designated space; and
based on a signal being acquired from the valid device, determine that the electronic device is located in the area in which the identified external electronic device is disposed within the designated space.

8. The electronic device of claim 7, wherein the instructions, when executed by at least one processor, individually and/or collectively, cause the electronic device to, based on a signal not being acquired from the valid device, determine that location estimation of the electronic device has failed.

9. A method of operating an electronic device, the method comprising:
identifying information related to first signal strength patterns of multiple external electronic devices disposed within a designated space;
generating a second signal strength pattern of the electronic device through scanning related to operating frequencies of the multiple external electronic devices;
based on a signal strength pattern corresponding to the second signal strength pattern existing among the first signal strength patterns, identifying an external electronic device having the signal strength pattern corresponding to the second signal strength pattern; and
identifying a location of the electronic device, based on a location at which the external electronic device is disposed within the designated space.

10. The method of claim 9, wherein the generating of the second signal strength pattern comprises:
identifying the operating frequencies of the multiple external electronic devices;
transmitting a request signal related to location estimation, based on the identified operating frequencies; and
based on response signals corresponding to the request signal being received from at least some of the multiple external electronic devices, generating the second signal strength pattern, based on received signal strengths of the response signals.

11. The method of claim 10, wherein the generating of the second signal strength pattern comprises:
performing the scanning related to the operating frequencies of the multiple external electronic devices a designated number of times; and
generating the second signal strength pattern, based on a result of the scanning performed the designated number of times.

12. The method of claim 11, wherein the generating of the second signal strength pattern comprises:
identifying an average value of reception strengths of the response signals, based on the result of the scanning performed the designated number of times; and
generating the second signal strength pattern, based on the average value of the reception strengths of the response signals.

13. The method of claim 9, wherein the identifying of the external electronic device comprises:
identifying at least one external electronic device among the multiple external electronic devices, satisfying a designated similarity condition for a similarity between the first signal strength pattern and the second signal strength pattern; and
identifying, among the identified at least one external electronic device, an external electronic device, wherein the first signal strength pattern of the identified external electronic device has a highest similarity to the second signal strength pattern.

14. The method of claim 13, wherein the identifying of the location of the electronic device comprises:
identifying a valid device in an area in which the identified external electronic device is disposed within the designated space; and
based on a signal being acquired from the valid device, determining that the electronic device is located in the area in which the identified external electronic device is disposed within the designated space.

15. The method of claim 14, further comprising, based on a signal not being acquired from the valid device, determining that location estimation of the electronic device has failed.

16. The method of claim 13, further comprising, based on an external electronic device satisfying the designated similarity condition not existing, determining that location estimation of the electronic device has failed.

17. One or more non-transitory computer-readable storage media storing one or more computer programs including computer-executable instructions that, when executed by at least one processor of an electronic device individually and/or collectively, cause the electronic device to perform operations, the operations comprising:
identifying information related to first signal strength patterns of multiple external electronic devices disposed within a designated space;
generating a second signal strength pattern of the electronic device through scanning related to operating frequencies of the multiple external electronic devices;
based on a signal strength pattern corresponding to the second signal strength pattern existing among the first signal strength patterns, identifying an external electronic device having the signal strength pattern corresponding to the second signal strength pattern; and
identifying a location of the electronic device, based on a location at which the external electronic device is disposed within the designated space.

18. One or more non-transitory computer-readable storage media of claim 17, wherein the generating of the second signal strength pattern comprises:
identifying the operating frequencies of the multiple external electronic devices;
transmitting a request signal related to location estimation, based on the identified operating frequencies; and
based on response signals corresponding to the request signal being received from at least some of the multiple external electronic devices, generating the second signal strength pattern, based on received signal strengths of the response signals.

19. One or more non-transitory computer-readable storage media of claim 17, wherein the identifying of the external electronic device comprises:
identifying at least one external electronic device among the multiple external electronic devices, satisfying a designated similarity condition for a similarity between the first signal strength pattern and the second signal strength pattern; and
identifying, among the identified at least one external electronic device, an external electronic device, wherein the first signal strength pattern of the identified external electronic device has a highest similarity to the second signal strength pattern.

20. One or more non-transitory computer-readable storage media of claim 19, wherein the identifying of the location of the electronic device comprises:
identifying a valid device in an area in which the identified external electronic device is disposed within the designated space; and
based on a signal being acquired from the valid device, determining that the electronic device is located in the area in which the identified external electronic device is disposed within the designated space.
